(19) United States
(12) Patent Application Publication
(10) Pub. No.: US 2025/0044112 A1
(43) Pub. Date: Feb. 6, 2025

(54) INFORMATION PROCESSING DEVICE

(71) Applicant: TOYOTA JIDOSHA KABUSHIKI KAISHA, Toyota-shi (JP)

(72) Inventor: Tetsuro ISHII, Nagoya-shi (JP)

(73) Assignee: TOYOTA JIDOSHA KABUSHIKI KAISHA, Toyota-shi (JP)

(21) Appl. No.: 18/676,610

(22) Filed: May 29, 2024

(30) Foreign Application Priority Data
Aug. 2, 2023 (JP) 2023-126022

(51) Int. Cl. G01C 21/36; G06Q 50/40

(52) U.S. Cl. CPC G01C 21/3617; G06Q 50/40

(57) ABSTRACT

In the information processing device, the control unit acquires the current position of the vehicle and the living area of the user of the vehicle. In response to the current position of the vehicle being out of the living area of the user, the control unit specifies a genre for proposal that is a genre in which the number of visits is equal to or greater than a predetermined threshold value among genres of the facilities that the user has visited in the vehicle in the past. The control unit determines a facility for proposal, which is a facility belonging to a genre for proposal, from among facilities located in a predetermined range including the current position of the vehicle. The control unit outputs information of the determined proposal facility.

### CROSS-REFERENCE TO RELATED APPLICATION

This application claims priority to Japanese Patent Application No. 2023-126022 filed on Aug. 2, 2023, incorporated herein by reference in its entirety.

### BACKGROUND

### 1. Technical Field

The present disclosure relates to an information processing device.

### 2. Description of Related Art

There is known a technology in which a visiting place that satisfies a condition associated with a user is selected from among candidates for the visiting place and information on the selected visiting place is provided to the user (see, for example, Japanese Unexamined Patent Application Publication No. 2018-100890 (JP 2018-100890 A)).

### SUMMARY

An object of the present disclosure is to provide a technology capable of improving convenience for a user in proposing a facility to visit by a vehicle.

One aspect of the present disclosure provides an information processing device. In that case, the information processing device includes, for example, a control unit configured to execute:
acquiring a current position of a vehicle of a user;
acquiring a living area of the user;
identifying, based on a fact that the current position is outside the living area, a genre for proposal in which the number of visits is equal to or larger than a predetermined threshold value among genres of facility that the user visited by the vehicle in a past;
determining, in response to the identifying the genre for proposal, a facility for proposal that belongs to the genre for proposal from among facilities located in a predetermined range including the current position; and
outputting information on the facility for proposal in response to the determining the facility for proposal.

The present disclosure can also be regarded as an information processing method in which a computer executes processing of the information processing device. The present disclosure can also be regarded as an information processing program for causing a computer to execute the information processing method or a non-transitory storage medium storing the information processing program.

According to the present disclosure, it is possible to provide the technology capable of improving the convenience for the user in proposing a facility to visit by the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically illustrating a configuration example of a system according to an embodiment;

FIG. 2 is a diagram illustrating an example of history information according to the embodiment;

FIG. 3 is a diagram illustrating exemplary data stored in a user-management DB according to the embodiment;

FIG. 4 is a diagram illustrating an example of information stored in a facility-management DB according to the embodiment; and

FIG. 5 is a flowchart illustrating an example of a process flow executed by the server according to the embodiment.

### DETAILED DESCRIPTION OF EMBODIMENTS

It is conceivable to propose a facility to be a visit destination to a user who moves in a vehicle. Incidentally, when the user moves in the living area by the vehicle, it is highly likely that the facility of the visit destination of the user is determined. Therefore, when the above-described proposal is made when the user moves in the living area by the vehicle, the user may learn the troublesomeness and the convenience may be impaired. Therefore, there is a need for a technique for improving convenience in proposing a facility to be visited by a vehicle.

Therefore, in the information processing device according to the present disclosure, the control unit acquires the current position of the vehicle of the user. The acquisition of the current position of the vehicle of the user may be performed by transmitting the current position from the vehicle to the information processing device triggered by activation of the drive system of the vehicle (for example, ignition switch on or power switch on) or activation of the car navigation system mounted on the vehicle. Further, in the information processing device according to the present disclosure, the control unit acquires a living area of the user. In an example, the living area of the user may be a predetermined area including a base of the user. The location of the user may be, for example, a home of the user, a work place of the user, or a storage location of the vehicle of the user. The predetermined area may be, for example, an area within a predetermined distance centered on the base of the user, or an area including the base of the user (for example, a ward, a city, a town, a village, or the like). The base of the user may be specified from a movement history or the like of the vehicle of the user, or may be registered in advance in a storage device or the like of the information processing device.

The control unit of the information processing device according to the present disclosure specifies a genre for proposal in response to the current position of the vehicle of the user being out of the living area of the user. In an example, the control unit identifies, as a genre for proposal, a genre in which the number of visits is equal to or greater than a predetermined threshold value among genres of a facility that the user has visited in the vehicle in the past. As used herein, the “genre” is, for example, a cafe, a ramen shop, a Chinese restaurant, a French restaurant, an Italian restaurant, a family restaurant, a convenience store, a supermarket, a shopping mall, a home center, an art museum, a museum, a movie theater, a karaoke shop, or the like.

The genre of the facility that the user has visited in the past may be transmitted from the vehicle to the information processing device every time the user moves in the vehicle, and may be accumulated in a storage device or the like of the information processing device. In this case, in an example, the information of the facility where the vehicle is parked, the parking date and time, and the like may be transmitted from the vehicle to the information processing device by using, for example, a stop (for example, an ignition switch off or a power switch off) of the drive system of the vehicle of the user as a trigger.

The predetermined threshold value may be a common value in all genres, but may be set for each genre. In an example, a predetermined threshold value may be set to a value larger than a genre of a leisure facility such as an art museum in a genre of a restaurant type such as a cafe, a genre of a grocery store type such as a supermarket, and a genre of a daily necessity shop type such as a convenience store.

In specifying the genre for proposal, the control unit may specify the genre for proposal in accordance with the time zone in which the current position of the vehicle is acquired in addition to the number of visits. That is, the control unit may specify a genre in which the number of visits in the same time period as the time period in which the current position of the vehicle is acquired is equal to or larger than a predetermined threshold as a genre for proposal. In this case, the time zone may be classified into a time zone at dawn (e.g., a time zone from 0 AM to 3 AM), a time zone in the early morning (e.g., a time zone from 3 AM to 6 AM), a time zone in the morning (e.g., a time zone from 6 AM to 9 AM), a time zone before noon (e.g., a time zone from 9 AM to 12 AM), a time zone after noon (e.g., a time zone from 0 PM to 3 PM), a time zone in the evening (e.g., a time zone from 3 PM to 6 PM), a time zone at night (e.g., a time zone from 6 PM to 9 PM), and a time zone at midnight (e.g., a time zone from 9 PM to 12 PM).

In specifying the genre for proposal, the control unit may specify the genre for proposal in accordance with the attribute of the day on which the current position of the vehicle is acquired in addition to the number of visits. That is, the control unit may specify, as the genre for proposal, a genre in which the number of visits on the day of the same attribute as the day on which the current position of the vehicle is acquired is equal to or greater than a predetermined threshold value. The attribute of the date on which the current position of the vehicle is acquired may be, for example, the day of the week of the target day, whether the target day is a holiday, or the season of the target day.

In the information processing device according to the present disclosure, when the genre for proposal is identified, the control unit determines a facility (a facility for proposal) belonging to the genre for proposal from among facilities located in a predetermined range including the current position of the vehicle. In this case, the information processing device may include a database that associates and stores the location of each facility and the genre of each facility for a plurality of facilities. In this case, the control unit may first extract a facility located in a predetermined range by referring to the location of each facility stored in the database. Subsequently, the control unit may identify the facility belonging to the genre for proposal as the facility for proposal by referring to the genre of the extracted facility. The facility for proposal identified in this way is not limited to one, and may be a plurality of facilities.

In the information processing device according to the present disclosure, when the proposal facility is determined, the control unit outputs information of the proposal facility. Outputting the information of the proposal facility includes outputting the information to an output device (for example, a display device of a car navigation system or a display device of a display audio) mounted on the vehicle through a network.

According to the information processing device of the present disclosure, a proposal facility is proposed only when a user moves outside a living area unfamiliar to the user by a vehicle. Therefore, it is possible to suppress the user from feeling troublesomeness. In addition, in a case where the user moves outside the living area by the vehicle, it is possible to propose a facility having a genre suitable for the preference of the user. Accordingly, it is possible to enhance the convenience for the user.

Hereinafter, an embodiment of the present disclosure will be described with reference to the drawings. The hardware configuration, the module configuration, the functional configuration, and the like described in the following embodiments are not intended to limit the technical scope of the disclosure only thereto unless otherwise specified.

### Embodiment

Embodiments of the present disclosure will be described with reference to the drawings. In the present embodiment, an example is described in which the information processing device according to the present disclosure is applied to a system that provides information of a facility for proposal.

### System Configuration

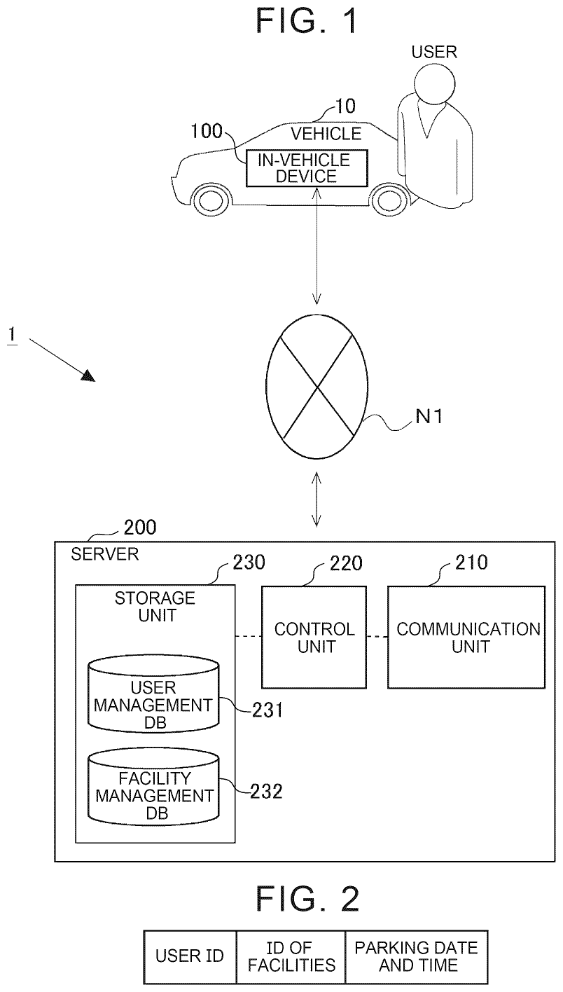

FIG. 1 is a block diagram schematically illustrating a configuration example of a system 1 according to the present embodiment. The system 1 according to the present embodiment includes an in-vehicle device 100 and a server 200. In the example illustrated in FIG. 1, only one in-vehicle device 100 is illustrated, but a plurality of in-vehicle devices 100 may be included in the system 1.

The in-vehicle device 100 is a computer mounted on the vehicle 10 of the user. In one embodiment, the present disclosure includes a car navigation system, a communication device, an ECU, and the like. When the drive system of the vehicle 10 is activated (for example, when an ignition switch, a power switch, or the like is switched from off to on), the in-vehicle device 100 according to the present embodiment has a function of acquiring a current position of the vehicle 10 (in-vehicle device 100) and transmitting position information including the acquired current position to the server 200. The present position is acquired through a GPS receiver included in the car navigation system. The location data transmitted from the in-vehicle device 100 to the servers 200 includes, in one embodiment, a user ID and a present location. The user ID is an identifier of the user of the vehicle 10. The user ID may be an identifier of the in-vehicle device 100.

Further, when the drive system of the vehicle 10 is stopped (for example, when the ignition switch or the power switch is switched from on to off), the in-vehicle device 100 according to the present embodiment has a function of transmitting the history information to the server 200. In the present embodiment, “when the drive system of the vehicle 10 is stopped” may be referred to as “when the vehicle 10 is parked”. As illustrated in FIG. 2, the history data includes a user ID, a facility ID, a parking date and time, and the like. The user ID is the same as the user ID included in the above-described position data. The facility ID is an identifier of a facility in which the vehicles 10 are parked. The parking date and time is the date and time when the vehicle 10 is parked (the date and time when the ignition switch or the power switch is switched from on to off). When the facility where the vehicle 10 is parked is a base of the user, the in-vehicle device 100 may not transmit the history information to the server 200. The base of the user is a home of the user, a work place of the user, a storage place of the vehicle 10 of the user, or the like.

Returning to the description of FIG. 1, the server 200 is a computer operated by a business operator involved in a service for providing information on a proposal facility. The servers 200 can be configured as computers having processors, such as CPU or GPU, main storage devices, such as RAM and ROM, and secondary storage devices, such as EPROM, hard disk drives, or removable media. The secondary storage device of the servers 200 stores an operating system (OS), various programs, various tables, and the like. The processor of the server 200 loads the program stored in the auxiliary storage device into the mounting work area of the main storage device and executes the program, thereby realizing each function matching a predetermined purpose as described later. However, some or all of the functions of the servers 200 may be realized by hardware circuitry such as Application Specific Integrated Circuit (ASIC) or Field Programmable Gate Array (FPGA).

The server 200 according to the present embodiment has a function of receiving the history information transmitted from the in-vehicle device 100 and storing the received history information for each user. In addition, the server 200 according to the present embodiment has a function of determining a proposal facility using the reception of the position information transmitted from the in-vehicle device 100 as a trigger, and transmitting information on the determined proposal facility to the in-vehicle device 100. As illustrated in FIG. 1, the server 200 that realizes these functions includes a communication unit 210, a control unit 220, and a storage unit 230.

The communication unit 210 is a communication interface for connecting the servers 200 to a network N1. The communication unit 210 connects to a network N1 through, for example, a LAN or Wi-Fi (registered trademark), and communicates with the in-vehicle device 100 through a network N1. The network N1 is, for example, a WAN or another communication network that is a global public communication network such as the Internet.

The control unit 220 is a software module realized by the processor of the server 200 executing a program stored in the auxiliary storage device. When receiving the history information transmitted from the in-vehicle device 100, the control unit 220 stores the received history information in a user management DB 231 described later.

In addition, when the position information is received from the in-vehicle device 100, the control unit 220 determines whether the current position included in the position information (the current position of the vehicle 10) is outside the living area of the user. This determination is performed based on data stored in a user management DB 231 described later. When it is determined that the current position of the vehicle 10 is outside the living area of the user, the control unit 220 determines a proposal facility and transmits the determined proposal facility information to the in-vehicle device 100.

An example of a method of determining a facility for proposal will now be described. First, the control unit 220 identifies a genre for proposal based on information stored in a user management DB 231 described later. The genre for proposal is a genre in which the number of visits is equal to or greater than a predetermined threshold value among the genres of the facilities that the user has visited in the vehicle 10 in the past. In one embodiment, the control unit 220 aggregates the number of visits of the facilities visited by the user for one month (one month up to the day preceding the target date) before the target date (the day on which the position information is received) by genre based on the information of the user management DB 231 described later. The control unit 220 identifies a genre whose aggregation result is equal to or larger than a predetermined threshold as a genre for proposal.

Note that the predetermined threshold value may be set to a common value in all genres, but is set for each genre in the present embodiment. In an example, in a genre of a restaurant type such as a cafe, a genre of a grocery shop type such as a supermarket, and a genre of a daily necessity shop type such as a convenience store, a predetermined threshold value may be set to a larger value than a genre of an entertainment facility type such as an art museum. This is because the number of visits tends to be larger in the categories of restaurants, grocery stores, and daily necessity stores than in the categories of entertainment facilities, regardless of the preference of the user.

When the genre for proposal is identified, the control unit 220 determines a proposal facility from among facilities located within a predetermined range including the current position of the vehicle 10. The predetermined range may be a range from several km to several tens of km of radii centered on the current position of the vehicle 10, or may be a region (such as a ward, a city, a town, or a village) including the current position of the vehicle 10. The facility for proposal is a facility belonging to the genre for proposal. Determination of the proposed facility is performed based on data stored in a facility management DB 232 described later. Note that the number of facilities for proposal is not limited to one, and may be a plurality of facilities.

When the proposal facility is determined, the control unit 220 transmits information of the proposal facility (hereinafter, sometimes referred to as “proposal information”) to the in-vehicle device 100. The proposal information may be information including a command for displaying a location, a name, a genre, and the like of the proposal facility on the map screen of the car navigation system, or information including a command for displaying a list of proposal facilities (a list including a name, a genre, a distance length from the current location, and the like of each proposal facility) on an in-vehicle display device (for example, a display device of a car navigation system, a display device of a display audio, and the like).

Next, the storage unit 230 is a storage area constructed in the auxiliary storage device of the server 200. In the storage unit 230 according to the present embodiment, a user management DB 231 and a facility management DB 232 are constructed. The user management DB 231 and the facility management DB 232 are relational databases constructed by the processor of the server 200 executing a program of Database Management System (DBMS).

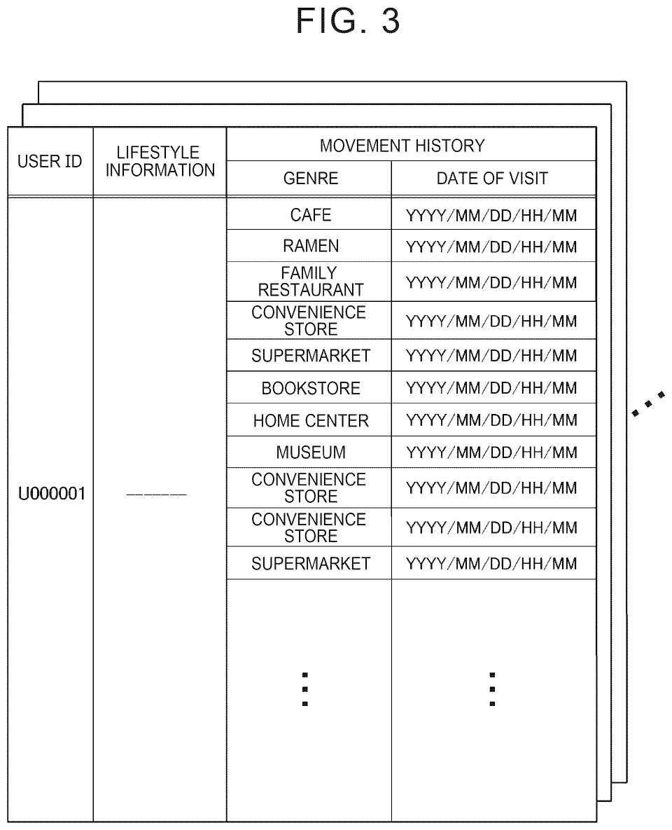

FIG. 3 is a diagram illustrating exemplary data stored in a user management DB 231. In the exemplary embodiment illustrated in FIG. 3, the user management DB 231 includes a plurality of tables (hereinafter, also referred to as “user information tables”) for each user. The user information tables store user ID, living area information, and travel history. A user ID is an identity of an individual user. The user ID may be an identifier of the vehicle 10 or an identifier of the in-vehicle device 100. The living sphere information is information indicating a living sphere of each user. As an example, a living area may have geographic coordinates ranging from a few km to tens of km in radii centered at the locations of the users. As another example, the life zone information may be geographic coordinates of a region (e.g., a ward, a city, a town, or a village) including a base of each user. As described above, the base of the user may be a home of the user, a work place of the user, or a storage place of the vehicle 10 of the user. The history information is information related to a facility visited by each user in the vehicle 10 in the past. In the example illustrated in FIG. 3, the history information includes a plurality of records (hereinafter, sometimes referred to as “movement history records”) for each facility visited by each user in the past. Each movement history record includes a genre field, a visit date and time field, and the like. The genre of each facility that the user has visited in the vehicle 10 in the past is registered in the genre field. In the visit date and time field, the date and time when the user visits each facility in the vehicle 10 in the past is registered. Such a movement history record is added by the control unit 220 each time the communication unit 210 receives the history information transmitted from the in-vehicle device 100. Details of addition of the movement history record will be described later.

In the example illustrated in FIG. 3, “cafe”, “ramen shop”, “family restaurant”, “convenience store”, “supermarket”, “bookstore”, “home center”, “museum”, and the like are illustrated as genres of the facility, but the present disclosure is not limited thereto. The genre of the facility may be appropriately changed according to the embodiment. The configuration of the user management DB 231 is not limited to that shown in FIG. 3, and information registered in the user management DB 231 can be added, omitted, or changed.

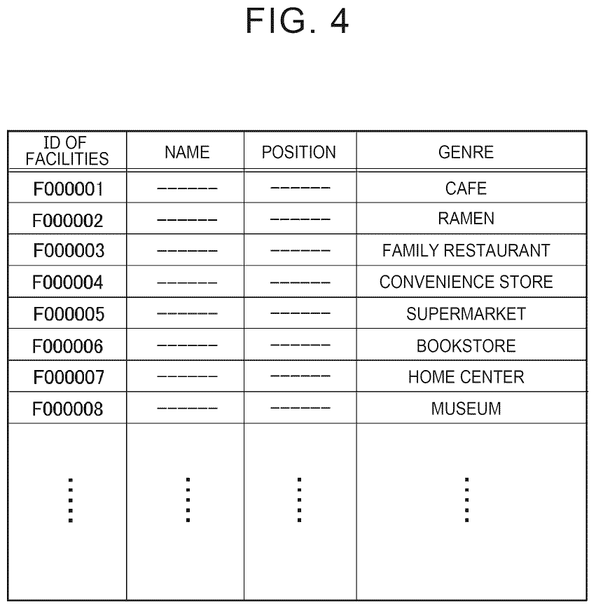

FIG. 4 is a diagram illustrating an example of information stored in a facility management DB 232; In the embodiment illustrated in FIG. 4, the facility management DB 232 includes a plurality of records (hereinafter, also referred to as “facility data records”) for each facility. Each facility info record has respective fields such as facility ID, name, location, and genre. In the facility ID field, identifiers of respective facilities are registered. The name of each facility is registered in the name field. In the location field, the location of each facility (for example, the geographic coordinates of the location of each facility) is registered. In the genre field, genres of each facility (for example, “cafe”, “ramen store”, “family restaurant”, “convenience store”, “supermarket”, “bookstore”, “home center”, “museum”, and the like) are registered. Note that the configuration of the record stored in the facility management DB 232 is not limited to that shown in FIG. 4, and fields can be added, omitted, or changed as appropriate.

Here, the addition of the migration history record constituting the history data of the user management DB 231 will be described. When the communication unit 210 receives the history information transmitted from the in-vehicle device 100, first, the control unit 220 accesses the facility management DB 232 by using the facility ID included in the history information (see FIG. 2) as an argument, and specifies the facility information record in which the information matching the facility ID is registered in the facility ID field. The control unit 220 specifies the genre registered in the genre field of the specified facility information record. The control unit 220 generates a new movement history record based on the identified genre and the parking date and time included in the history information. At this time, the genre specified above is registered in the genre field of the new movement history record. In addition, the parking date and time included in the history information is registered in the visit date and time field of the new movement history record. When a new move history record is generated in this way, the control unit 220 accesses the user management ID included in the history information as an argument to the user management DB 231, and specifies the user information table associated with the user ID. Then, the control unit 220 adds the new movement history record generated above to the specified user information table.

### Processing Flow

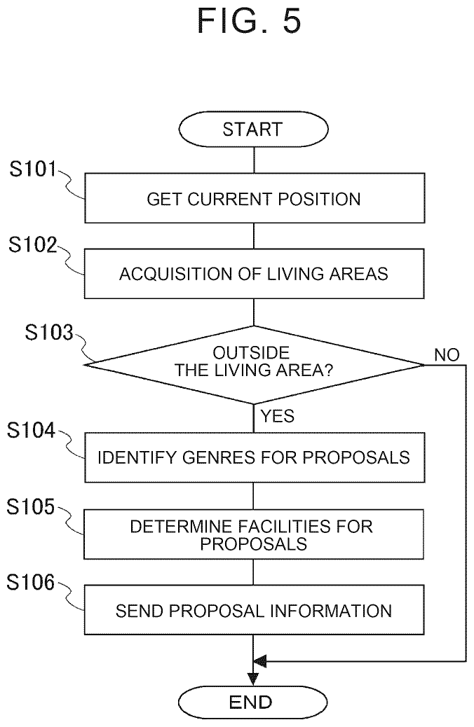

A processing flow executed by the server 200 according to the present embodiment will be described with reference to FIG. 5. FIG. 5 is a flowchart showing a processing routine executed by the server 200 triggered by reception of the position information transmitted from the in-vehicle device 100. Note that the execution subject of the processing routine in FIG. 5 is a processor of the server 200, but here, the description is performed mainly on the software module (the control unit 220) of the server 200.

When the position information transmitted from the in-vehicle device 100 is received by the communication unit 210 of the server 200, the control unit 220 acquires the current position (the current position of the vehicle 10) included in the position information (S101). Upon completion of S101 process, the control unit 220 executes S102 process.

In S102, the control unit 220 acquires the living area of the user of the vehicle 10. Specifically, the control unit 220 first identifies the user information table associated with the user ID by accessing the user management DB 231 using the user ID included in the position information as an argument. Next, the control unit 220 acquires the living area information stored in the specified user information table. Upon completion of S102 process, the control unit 220 executes S103 process.

In S103, the control unit 220 determines whether the present position acquired by S101 is outside the living area acquired by S102. When the present position acquired by S101 is within the living area acquired by S102 (negative determination by S103), the control unit 220 ends the process. In this case, the transmission of the proposal information from the server 200 to the in-vehicle device 100 is not performed. When the present position acquired by S101 is outside the living area acquired by S102 (affirmative determination is made by S103), the control unit 220 executes S104 process.

In S104, the control unit 220 identifies genres for suggestion. Specifically, the control unit 220 extracts, from the movement history records stored in the user information table specified by S102, a movement history record in which the date and time of one month before the target date (the date on which the position information is received) (one month before the date on which the target date is received) is registered in the visit date and time field. Subsequently, the control unit 220 calculates the number of visits for each genre in the above-described one month by counting the number of extracted movement history records for each genre. The control unit 220 identifies a genre whose calculated number of visits is equal to or greater than a predetermined threshold as a genre for proposal. As described above, the predetermined threshold value is set for each genre. In one example, a predetermined threshold may be set to four times for genres such as cafes, ramen stores, supermarkets, and convenience stores, and a predetermined threshold may be set to two times for genres such as bookstores and museums. In this case, if the number of visits to a facility belonging to a genre such as a cafe, a ramen store, a supermarket, or a convenience store is four or more, the genre is identified as a genre for proposal. In addition, if the number of visits to a facility belonging to a genre such as a bookstore or a museum is two or more, the genre is identified as a genre for proposal. Upon completion of S104 process, the control unit 220 executes S105 process.

In S105, the control unit 220 determines a proposal-use facility. Specifically, first, the control unit 220 sets a predetermined area including the present position of the vehicle 10 acquired by S101. As described above, the predetermined range may be a range from several km to several tens of km of radii centered on the current position of the vehicle 10, or may be a region (such as a ward, a city, a town, or a village) including the current position of the vehicle 10. The control unit 220 accesses the facility management DB 232 and selects a facility data record in which the location registered in the location field belongs to a predetermined area. The control unit 220 identifies, from among the selected facility information records, a facility record in which a genre matching the genre for proposal is registered in the genre field. The control unit 220 determines a facility corresponding to the identified facility record as a facility for proposal. Upon completion of S105 process, the control unit 220 executes S106 process.

In S106, the control unit 220 transmits the proposal information to the target in-vehicle device 100. The proposal information may be information including a command for displaying a position, a name, a genre, and the like of a proposal facility on a map screen of a car navigation system of the vehicle 10, or information including a command for displaying a list of proposal facilities (a list including a name, a genre, a distance length from the current position, and the like of each proposal facility) on a display device (for example, a display device of a car navigation system, a display device of a display audio, and the like) mounted on the vehicle 10. When S106 processing is finished, the control unit 220 ends the execution of this processing routine.

### Operation and Effect of Embodiments

In the above-described embodiment, the information of the proposal facility is presented to the user of the vehicle 10 on condition that the current position of the vehicle 10 is outside the living area. Accordingly, when the current position of the vehicle 10 is within the living area, it is possible to suppress the information of the proposal facility from being presented to the user of the vehicle 10. Therefore, it is possible to present the information of the proposal facility to the user while suppressing the user from experiencing troublesomeness. As a result, the convenience of the user in presenting the information of the proposal facility can be improved.

Further, according to the present embodiment, in a case where the current position of the vehicle 10 is outside the living area, a facility belonging to a genre whose number of visits is equal to or larger than a predetermined threshold among genres of a facility that the user has visited in the vehicle 10 in the past is proposed to the user as a facility for proposal, and a predetermined threshold at that time is set for each genre. That is, for a genre in which the number of visits tends to increase regardless of the preference of the user, a predetermined threshold value is set to a relatively large value. As a result, a facility belonging to a genre suitable for the user's preference can be presented to the user as a facility for proposal.

In the present embodiment, the server 200 corresponds to an “information processing device” according to the present disclosure. The control unit 220 of the server 200 corresponds to a “control unit” according to the present disclosure.

### OTHER EMBODIMENTS

The above-described embodiment is merely an example, and the present disclosure can be appropriately modified and implemented without departing from the gist thereof. For example, identification of the genre for proposal may be performed in accordance with the time period (hereinafter, sometimes referred to as “target time period”) in which the position information from the in-vehicle device 100 is received in addition to the number of past visits. That is, the control unit 220 may specify a genre in which the number of visits in the same time zone as the target time zone is equal to or greater than a predetermined threshold as a genre for proposal. In this case, the control unit 220 first extracts, from among the movement history records stored in the user management DB 231, a movement history record in which the date and time of one month preceding the target date is registered in the visit date and time field, and the time belonging to the same time zone as the target time zone is registered in the visit date and time field. Subsequently, the control unit 220 calculates the number of visits for each genre in the same time period as the target time period in the above-described one month by counting the number of extracted movement history records for each genre. The control unit 220 identifies a genre whose calculated number of visits is equal to or greater than a predetermined threshold as a genre for proposal. As a result, a facility belonging to a genre suitable for the lifestyle pattern of the user can be presented to the user as a proposal facility.

As an example, the “time zone” said here may be classified into a time zone at dawn (e.g., a time zone from 0 AM to 3 AM), a time zone in the early morning (e.g., a time zone from 3 AM to 6 AM), a time zone in the morning (e.g., a time zone from 6 AM to 9 AM), a time zone before noon (e.g., a time zone from 9 AM to 12 AM), a time zone after noon (e.g., a time zone from 0 PM to 3 PM), a time zone in the evening (e.g., a time zone from 3 PM to 6 PM), a time zone at night (e.g., a time zone from 6 PM to 9 PM), a time zone at midnight (e.g., a time zone from 9 PM to 12 PM), and a time zone at midnight (e.g., a time zone from 9 PM to 12 PM).

In addition, identification of the genre for proposal may be performed in accordance with the attribute of the target day (the day on which the position information from the in-vehicle device 100 is received) in addition to the number of past visits. That is, the control unit 220 may specify, as the genre for proposal, a genre in which the number of visits on a day having the same attribute as the target day is equal to or greater than a predetermined threshold value. The “attribute” here may be a day of the week, may be whether or not a holiday, or may be a season. In such an embodiment, the movement history record stored in the user management DB 231 may include an attribute field for registering the attribute of the visit date in addition to the genre field and the visit date and time field. Then, the control unit 220 may extract a movement history record in which the date and time of one month preceding the target date among the movement history records stored in the user management DB 231 is registered in the visit date and time field, and information matching the attribute of the target date is registered in the attribute field. Further, the control unit 220 calculates the number of visits for each genre on the day of the same attribute as the target day in the above-described one month by counting the number of extracted movement history records for each genre. The control unit 220 identifies a genre whose calculated number of visits is equal to or greater than a predetermined threshold as a genre for proposal. As a result, a facility belonging to a genre suitable for the lifestyle pattern of the user can be presented to the user as a proposal facility.

Also, the processes and the configurations described in the present disclosure can be appropriately combined to be implemented as long as no technical contradiction occurs. Moreover, the processes described as being executed by one device may be shared and executed by a plurality of devices. Alternatively, the processes described as being executed by different devices may be executed by one device. In the computer system, it is possible to flexibly change the hardware configuration for implementing each function.

What is claimed is:

1. An information processing device comprising a control unit configured to execute:
acquiring a current position of a vehicle of a user;
acquiring a living area of the user;
identifying, based on a fact that the current position is outside the living area, a genre for proposal in which the number of visits is equal to or larger than a predetermined threshold value among genres of facility that the user visited by the vehicle in a past;
determining, in response to the identifying the genre for proposal, a facility for proposal that belongs to the genre for proposal from among facilities located in a predetermined range including the current position; and
outputting information on the facility for proposal in response to the determining the facility for proposal.

2. The information processing device according to claim 1, wherein the predetermined threshold value is set for each genre.

3. The information processing device according to claim 1, wherein the identifying the genre for proposal includes identifying, as the genre for proposal, a genre in which the number of visits in the same time frame as a time frame in which the current position was acquired is equal to or larger than the predetermined threshold value.

4. The information processing device according to claim 1, wherein the identifying the genre for proposal includes identifying, as the genre for proposal, a genre in which the number of visits on a day having the same attribute as an attribute of a day on which the current position was acquired is equal to or larger than the predetermined threshold value.
